(19) United States
(12) Patent Application Publication
(10) Pub. No.: US 2025/0217744 A1
(43) Pub. Date: Jul. 3, 2025

(54) SYSTEM FOR AND A METHOD OF GRAPH MODEL GENERATION

(71) Applicant: WESCO Distribution, Inc., Pittsburgh, PA (US)

(72) Inventors: Rafael Da Matta Navarro, Houston, TX (US); Avinash Wesley, New Caney, TX (US); Shashi Dande, Spring, TX (US); Kishor Saitwal, Sugarland, TX (US); Raja Vikram Raj Pandya, Katy, TX (US); Samuel Clayton, Imperial, PA (US); Miguel de la Salle Rousseau Twahirwa, Pittsburgh, PA (US); Akash Khurana, Houston, TX (US); Shreyas Bhat, Saint Johns, FL (US); Ashok Bajaj, Katy, TX (US); Merwan Mereby, Baton Rouge, LA (US)

(73) Assignee: WESCO Distribution, Inc., Pittsburgh, PA (US)

(21) Appl. No.: 18/866,853

(22) PCT Filed: May 17, 2023
(86) PCT No.: PCT/US2023/022548

§ 371 Date: Nov. 18, 2024

Related U.S. Application Data
(60) Provisional application No. 63/342,966, filed on May 17, 2022.

(51) Int. Cl. G06Q 10/0633; G06F 16/215; G06F 16/901; G06Q 10/08

(52) U.S. Cl. CPC G06Q 10/0633; G06F 16/215; G06F 16/9024; G06Q 10/08

(57) ABSTRACT

Systems, methods, and computer-readable storage media for graph model generation, and more specifically to generating graph models using supply chain data and operations. A system can receive, from a plurality of sources, sensor data, each piece of the sensor data including information associated with an exchange. The system can then parse, via at least one processor, the sensor data to identify components of each piece of the sensor data, resulting in parsed sensor data. The system resolves, via the processor, missing data within the parsed sensor data, resulting in parsed, resolved sensor data. The system can then map, via the at least one processor, the parsed, resolved sensor data to a graph data structure, the graph data structure having nodes and edges, and store the graph data structure in a graph database.

### BACKGROUND

### 1. Technical Field

The present disclosure relates to graph model generation, and more specifically to generating graph models using supply chain data.

### 2. Introduction

Understanding how a supply chain operates is part of any business.

### SUMMARY

Additional features and advantages of the disclosure will be set forth in the description that follows, and in part will be understood from the description, or can be learned by practice of the herein disclosed principles. The features and advantages of the disclosure can be realized and obtained by means of the instruments and combinations particularly pointed out in the appended claims. These and other features of the disclosure will become more fully apparent from the following description and appended claims, or can be learned by the practice of the principles set forth herein.

Disclosed are systems, methods, and non-transitory computer-readable storage media which provide a technical solution to the technical problem described.

A method for performing the concepts disclosed herein can include: receiving, from a plurality of sources at a computer system, sensor data, wherein each piece of the sensor data comprises information associated with an exchange; parsing, via at least one processor of the computer system, the sensor data to identify components of each piece of the sensor data, resulting in parsed sensor data; resolving, via the at least one processor, missing data within the parsed sensor data, resulting in parsed, resolved sensor data; mapping, via the at least one processor of the computer system, the parsed, resolved sensor data to a graph data structure, the graph data structure comprising nodes and edges, wherein each node and each edge of the graph data structure comprises metadata associated with the exchange; and storing the graph data structure in a graph database.

A system configured to perform the concepts disclosed herein can include: at least one processor; and a non-transitory computer-readable storage medium having instructions stored which, when executed by the at least one processor, cause the at least one processor to perform operations comprising: receiving, from a plurality of sources, sensor data, wherein each piece of the sensor data comprises information associated with an exchange; parsing the sensor data to identify components of each piece of the sensor data, resulting in parsed sensor data; resolving missing data within the parsed sensor data, resulting in parsed, resolved sensor data; mapping the parsed, resolved sensor data to a graph data structure, the graph data structure comprising nodes and edges; and storing the graph data structure in a graph database.

A non-transitory computer-readable storage medium configured as disclosed herein can have instructions stored which, when executed by a computing device, cause the computing device to perform operations which include: receiving, from a plurality of sources, sensor data, wherein each piece of the sensor data comprises information associated with an exchange; parsing the sensor data to identify components of each piece of the sensor data, resulting in parsed sensor data; resolving missing data within the parsed sensor data, resulting in parsed, resolved sensor data; mapping the parsed, resolved sensor data to a graph data structure, the graph data structure comprising nodes and edges; and storing the graph data structure in a graph database.

### BRIEF DESCRIPTION OF THE DRAWINGS

FIG. 1 illustrates an example system architecture;

FIG. 2 illustrates an example graph model framework;

FIG. 3 illustrates an example analysis workflow;

FIG. 4 illustrates conversion of a non-graph data structure into a graph model data structure;

FIG. 5 illustrates an example method embodiment; and

FIG. 6 illustrates an example computer system.

### DETAILED DESCRIPTION

Various embodiments of the disclosure are described in detail below. While specific implementations are described, it should be understood that this is done for illustration purposes only. Other components and configurations may be used without parting from the spirit and scope of the disclosure.

Graph models are probabilistic models in which a graph expresses the conditional dependence between different variables. These variables are represented as nodes, while the relationships between the nodes are expressed as edges. Traditional supply chain and operations data are not stored in graph models, but in entity tables in a tabular structure. Such tabular structures result in complicated merge queries to derive any meaningful analysis. The complication is due to the use of predefined structures, i.e., table definitions in terms of primary and foreign keys. These pre-defined structures generally vary from one database to another.

However, the building of a graph model which is capable of dynamically adapting to the structure variance of distinct databases, while simultaneously receiving new information to be added to existing models, represents a technical problem for which there is not currently a technical solution.

The methods, systems, and computer-readable storage media configured as disclosed herein can model supply chain and operations data into a graph data model. Graph data models created as disclosed herein can identify relationships between different entities according to their distribution records. Unlike traditional tabular structures for the supply chain and/or operations data (which require the use of primary keys, foreign keys, etc.), the graph data model disclosed herein can store relationships at the individual record level, with the respective nodes and edge names forming human-readable sentences, such that the relationships between entities represented by the nodes are understandable upon looking at a visual representation of the graph model. The graph data model also allows for more efficient queries (compared to tabular structure queries), with the queries being able to search for particular types of relationships between particular nodes.

When receiving data, the data can first be stored in different formats (e.g., different tabular schemas) in a data lake (i.e., a repository of data stored where the data is stored in its natural/raw/original format). The system can then access the “raw” data stored in the data lake, apply the methods and systems disclosed herein, and transform that raw data into a graph data model. In other configurations, rather than having a data lake/repository, the system can have access to multiple databases or data sources. From the data lake and/or databases, the data can be retrieved, and the graph model disclosed herein can be implemented on the data. If, for example, the data lake includes data from databases, each with a distinct data format, the system can clean/normalize the data such that the data is in a common format, then parse the data to identify relationships among entities as provided within the normalized data. Specifically, when parsing the data, the system can identify components of that data, components being grammatical components (nouns, verbs, conjunctions, pronouns, numbers, etc.) if the data is in prose format, components belonging to different types or classes if the data is in a non-prose format. Based on the identified relationships obtained from the parsed data, the system can create a graph model data structure. The graph model data structure can then be used to implement machine learning/Artificial Intelligence (A.I.) algorithms, identify patterns, and/or retrieve data in response to queries. Exemplary, non-proprietary types of A.I. algorithms can include: Centrality (e.g., to find the most trending products based on an exchange history), Community analysis (e.g., to find similar products based on buying patterns, and/or to recommend product groups based on products that are frequently purchased together), GraphML/Embeddings, Path optimization (e.g., to find relevant products that are not linked with the “Exchange Contract and Terms” node), Classification, Similarity, Topological link prediction, and Frequent pattern mining.

Consider the following example. A company wants to visualize their supply chain in real-time. To do so, the system can use a combination of (1) hardware sensors to track where objects are based on live signals from RFID (Radio Frequency Identification) tags, barcode scans, object recognition using cameras, etc., (2) virtual sensors, that constantly analyze databases for certain predefined changes or triggers that, when identified, cause the virtual sensor to react, and/or (3) databases/repositories where the data is stored. The sensor data can be received by a sensor interface, such as a server or other computing device, that can then combine the newly received data with the data from the databases. This sensor data and/or aggregated data can then be mapped to specific categories based on what information the data contains. Mapping, in this context, means to identify pieces of data that correspond to known categories or types of data. In other cases, mapping can include clustering the information based on commonalities. For example, if the data contains the names of customers, and the contract terms for those customers, the data may be mapped to categories such as “customers” and “contract terms.” If the data contains the names of specific products and the supplier of those products, the data may be mapped to categories such as “supplier” and “product.”

From the mapped data, the system then can construct a graph model, where the categories are represented as nodes, and the relationships between the categories (as defined by the data) are represented as edges connecting the nodes. These edges can be associated with verbs, such as “applies to,” “uses,” “is part of,” “has,” etc., that can be used by the system to form grammatically legible sentences from the graph model data structure. Thus if the graph model data structure has an entry that has a customer “Joe” who conducts business with an exchange according to “Standard Terms” contract terms and conditions, the system can perform a query for information related to customer Joe and the results can include “Standard Terms applies to Joe,” where the “applies to” language is determined by the type of edge between the nodes, Joe was found in the customer node, and Standard Terms was the other data associated with the edge that connected to Joe. In other configurations, the types of nodes, the relationships defined by the edges, and the resulting sentences which can be provided for queries, can all vary.

The information stored within the various nodes and edges of the graph data structure can include metadata about the entity, exchange, etc. An exchange, as described herein, can include any transfer of goods or services, such as (but not limited to) a transaction, a trade, a swap, a barter, a substitute, a gift, or any other interchange. For example, if an entity participating in the exchange is a business, the metadata stored with that entity may include (in addition to the name of the entity), an address for the entity. In an example of contract terms and conditions, the specifics associated with a given contract can be stored as metadata. The relationship defined by the edge between the specific entity and any given node may identify the date, location, amount, or other aspects of how the relationship was formed.

In some cases, the data provided by the sensors (real and virtual), data lake, and/or databases may be missing information. For example, if a company were to purchase another company and try to merge their own supply chain data with that of the other company, there may be aspects of the datasets where categories have different names, where the other company didn't keep sufficiently accurate records, or where there is simply missing data. In such cases, the system can parse the new data to identify the categories/relationships that are available, and identify the specific missing data. The system can then fill in the specific missing data based on known relationships, where the known relationships are obtained from the existing graph data model. If, for example, the newly obtained data contains a first specific entity is known to have a relationship with a second entity, however the newly obtained data fails to provide sufficient information for the relationship/edge to be formed, the system can “fill in” the relationship information based on similar relationships already known to the existing graph data model. Thus, if the existing graph data model identifies entity “AAA” as a supplier, and entity “BBB” as an exchange location, the system can look to other relationships that are already in the graph data model between AAA and BBB, then form a new relationship between the two accordingly. Metadata for that new relationship could be blank (because it was essentially produced without underlying information), or could contain a note indicating that it was implied/inferred/suggested.

The real and virtual sensors may record and report data at different frequencies and/or at different timestamps. As another example of filling in data, the system can resolve frequency and/or timing differences between data collected from the sensors. Preferably, the system resolves these differences by finding a common timestamp where all of the relevant sensors have recorded data. Additional datapoints can then be based on the common timestamp (where other data is adjusted based on the common timestamp) or can solely include points containing a common timestamp. If, for example, the system collects data from different sensors and/or databases and the timestamps for exchanges between entities do not match, or if there are time-warping problems among the sensors, the system can resolve those issues. In some cases, the system may average the timestamps, whereas in others the system may select the earlier (or later) of the timestamps. In yet other cases, the system may execute an additional search to see if any additional data can be found to identify the correct time that should be included.

The graph data model generated by the system can, for example, be used to map the supply chain for an entity, with information about where the products are located, their suppliers, the customers, what exchanges take place, the contracts between the various sub-entities, etc. Accordingly, exemplary nodes for such a supply chain can include: a supplier node that contains the names of entities who supply specific products; a product node containing the names of products being moved within the supply chain; a customer node identifying the names of customers purchasing the various products; an exchange location node identifying where the customer acquires the product(s); an exchange node identifying when/how the exchange occurred; and a sales contract and terms node, that relays information between the other nodes regarding the contract terms for the exchange. Other additional nodes may exist, such as, for example, a node identifying to which group(s) the customer belongs and/or account information for the customer.

The data received by the system that is parsed, normalized, and otherwise prepared for conversion to the graph data model can, in some instances, be self-referencing. In such cases, the graph data model generated as described herein can create an edge that loops back to the same node from which it extends. In such cases, referred herein as “Affinity” edges, the affinity edge can contain metadata describing the exchange or other information that resulted in the affinity edge.

Once the graph data model is created, the graph data model can be used by machine learning and/or A.I. analyses. There are speed advantages to using a graph data model for such analyses, where the complexity of the queries/responses is greatly reduced using a graph data model. The machine learning and/or A.I. algorithms can, for example, identify patterns within the graph data model that can then be reported to users. For example, if an analysis identifies a particular choke point within the supply chain modeled by a graph data model, that choke point can be reported to a user for future analysis. Likewise, if a particular pattern is detected by the analyses, that information can be reported to the user(s).

Once a graph data model is generated, it can be stored in a database of graph data models, with the advantage that queries to/from the graph data model database can be computationally simple compared to a tabular data structure. The graph data model database can, for example, store the graph data model(s) in memory as a store file, where each store file contains data for a specific part of the graph model (e.g., the nodes, the relationships, the labels, and their respective attributes). While a tabular data structure stores data in tables containing rows and using a strict schema (e.g., not allowing storing of content that is not explicitly specified in the schema definition), a graph data structure can store data as vertices (nodes, components) and edges (relationships). Each node type can represent an entity and the edges can define the various relationships between the different node types. The graph data model disclosed herein is fundamentally different from the tabular entity model as the graph data model treats the relationships as “first-class citizen,” which means individual data records can be referenced by a key-value pair, and that all records connected to an individual data record can be queried as well.

The disclosure now turns to the examples provided in the figures.

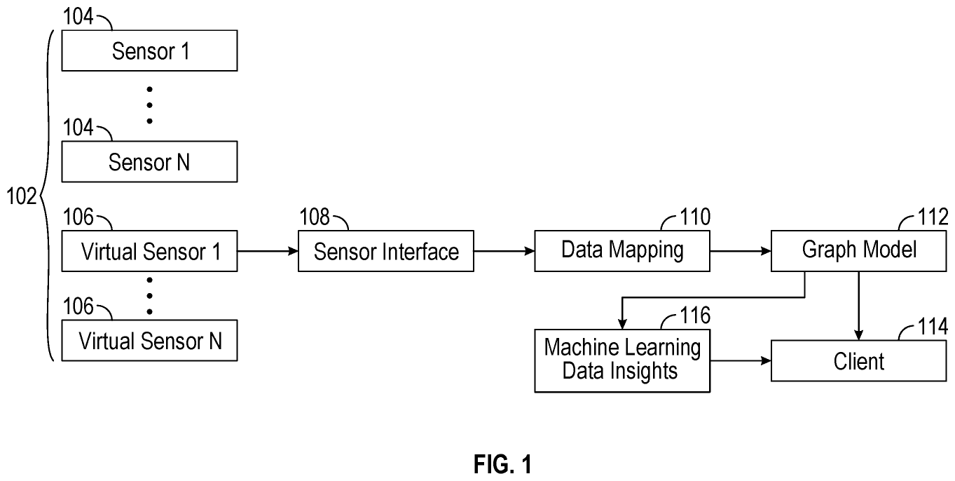

FIG. 1 illustrates an example system architecture. Illustrated are a plurality of sensors 102, that includes hardware sensors 104 as well as virtual sensors 106. These sensors 102 can collect and transmit data in various formats, e.g., text, numerical values, nominal values, etc. to a sensor interface 108. The sensor interface 108 can be a computer server, an integrated circuit (IC), switch, hub, or other networking component. The data from the sensors 102 is transmitted from the sensor interface 108 into a processor, that can perform data aggregation and/or data parsing. The processor can also implement data cleaning to resolve missing data and null values, resolve time-warping problems amongst the sensors 102, and perform data mapping 110 to convert the raw sensor values provided by the sensors 102 into a data structure with nodes (also called vertices) and edges. If the system already has an existing graph model 112, the newly generated nodes and edges will be added to that graph model 112. Alternatively, if there is no existing model, the system will use the nodes and edges to form a graph model 112. That graph model 112 can then be forwarded directly to the client 114 for visualization and/or analysis. The graph model 112 can also be used for machine learning 116, resulting in data insights that can be forwarded to the client 114.

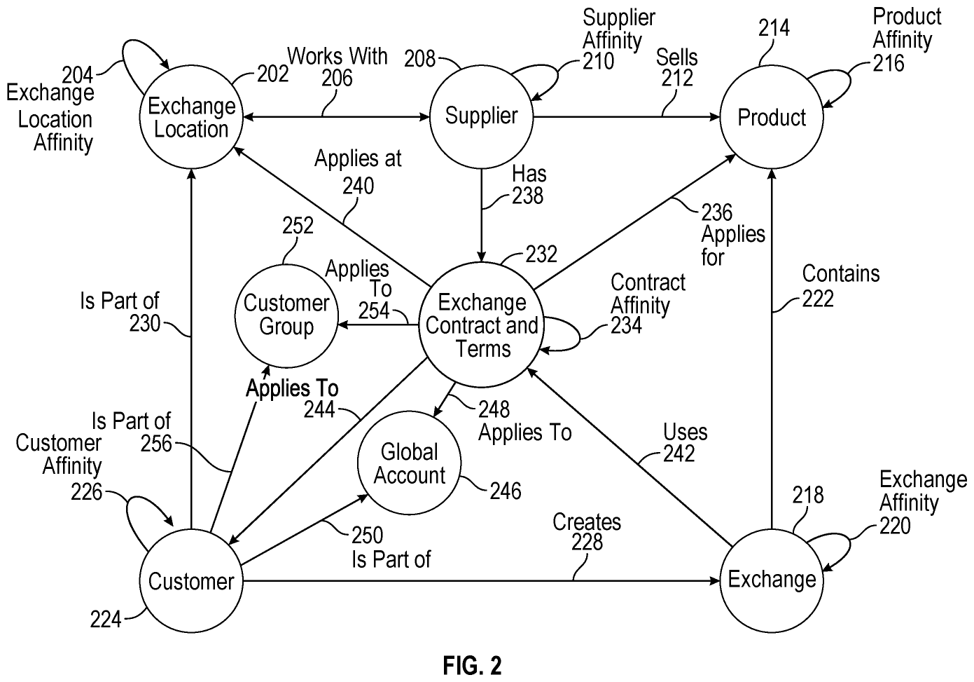

FIG. 2 illustrates an example graph model framework. While the example graph model framework is specific to a supply chain, in other instances the principles disclosed herein may result in graph model framework with different nodes, edges/relationships, etc. As illustrated there the graph model contains nodes for customers 224, suppliers 208, products 214, exchange location 202, the exchange itself 218, as well as exchange contract and terms 232. Additional nodes associated with the customer and the exchange contract and terms can include a customer group node 252 which records groups to which the customer belongs and/or a global account node 246 associated with the customer.

The customer node 224 can store information about the customer, such as (but not limited to) name, address (physical and/or virtual), and contact information.

The customer group node 252 can contain information about the groups to which the customer belongs. In some cases, these groups can be determined by the customer, such as when or where they join an association, organization, or other group for the purpose of having a common contract and terms. As an example, this could be a customer who receives discounts through their job, or a customer who has joined an organization and receives a distinct contract and terms than if they had formed a contract by themselves. In other cases, these groups can be determined by the system based on behavior, socio-economic status, demographics, location, etc. For example, the system may offer discounts to students or seniors, or charge premiums to customers in locations identified as having extra discretionary income.

The global account node 246 can store information about entities with international and/or national accounts. Please note that these accounts are not bank accounts. Instead, the accounts identify relationships between the entity and customers, and may contain details regarding their relationship. The global account can be, for example, a reference number for customers that are treated preferentially by the entity. These accounts can have a dedicated team (from the entity's company) to support their needs and provide first class service. They can also have special pricing contracts due to exchange volume.

The exchange location node 202 can record information about where and/or how the exchange takes place. In some examples (such as physical goods) this can be a physical location, whereas in other examples (such as software or non-tangible goods) this can be a time, a network address (such as an IP address, email address, or GUID (globally unique identifier), etc. Additional examples of locations recorded by the exchange location node 202 can include a supplier/manufacturer's warehouse, or a distribution company's warehouse (also known as a distribution center, “DC”).

The supplier node 208 can store information about the supplier of goods and/or

services. This can, like the customer node 224, include information such as (but not limited to) name, address (physical and/or virtual), and contact information.

The product node 214 can contain information about the product being exchanged. This can be, for example, the name of the product being exchanged, the quantity exchanged, the type or version being exchanged, etc. The product node 214 can also contain product attribution and performance details. For example, for a light bulb, the product node 214 may record details regarding the Watts-Kelvin relationship of the light bulb.

The exchange node 218 can record additional details about the exchange occurring between the customer and the supplier, such as time, consideration required, etc.

The exchange contract and terms node 232 can store details on the contract/relationship between the supplier and distributor. The contract term can, for example, have a start date and an end date. It can also contain information regarding discounts, consideration, legality, capacity, awareness, jurisdiction, or other parts of a contract. These contract details can be specific to one or more customers, or can be generic contracts.

Between each of these nodes 202, 208, 214, 218, 224, 252, 246, 232 are edges that have attributes based on the nodes to which they are connected. These attributes allow the system to form legible sentences based on the data in the nodes connected to a respective edge. For example, the edge 256 between the customer node 224 and the customer group node 252 has the attribute “is part of” 256. If a query were made regarding a particular customer “Ken” and what group(s) Ken belongs to, the system could return, for example, “Ken” “is part of” “Special Group A.” Other exemplary attributes between nodes illustrated can include:
Exchange location node 202 & Supplier node 208—“works with” 206
Supplier node 208 & Product node 214—“sells” 212
Product node 214 & Exchange node 218—“contains” 222
Customer node 224 & Exchange node 218—“creates” 228
Customer node 224 & Exchange location node 202—“is part of” 230
Customer node 224 & Exchange contract and terms node 232—“applies to” 244
Customer node 224 & Global Account node 246—“is part of” 250
Global Account node 246 & Exchange contract and terms node 232—“applies to” 248
Customer group node 252 & Exchange contract and terms node 232—“applies to” 254
Exchange location node 202 & Exchange contract and terms node 232—“applies at” 240
Supplier node 208 & Exchange contract and terms node 232—“has” 238
Product node 214 & Exchange contract and terms node 232—“applies for” 236
Exchange node 218 & Exchange contract and terms node 232—“uses” 242

As illustrated, some of these relationships can be directional (illustrated using a single arrowhead), whereas in some cases the relationships can be bi-directional (illustrated by the line having dual arrowheads). In addition, in some instances, there may be self-referencing relationships. As illustrated, self-referencing relationships loop back to the node from which they originate, and are described using the word “Affinity” 204, 210, 216, 234, 220, 226. In the illustrated example:
Exchange Location Affinity 204 can capture exchange location proximity. It can, for example, be a weighted average of exchange location address and a regional roll-up.
Supplier Affinity 210 can score similar suppliers by a weighted average of the common customers and similar product catalog.
Product Affinity 216 can score similar products based on the product catalog.
Contract Affinity 234 can score similar contracts based on the contract types (e.g., customer and sales location tuple, customer group, and global accounts).
Customer Affinity 226 can score similar customers based on industry segment.
Exchange Affinity 220 can score similar exchanges based on the weighted average of similar stock-keeping unit (SKU), UPC numbers, and similar special pricing agreements.

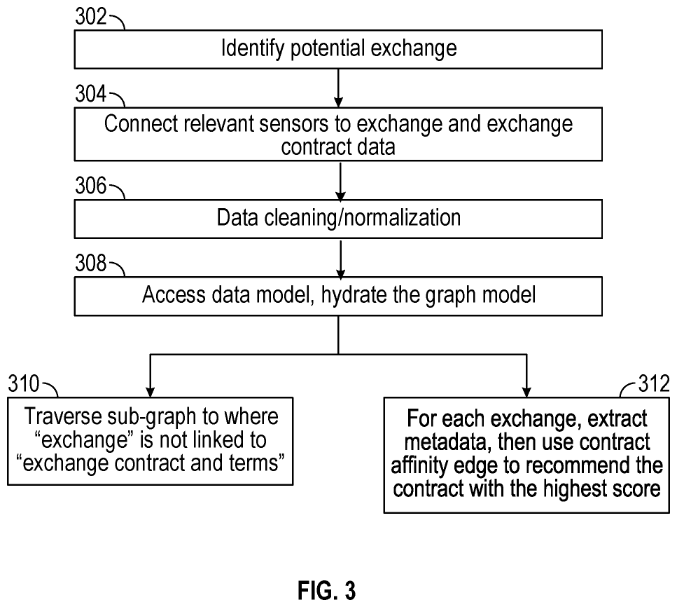

FIG. 3 illustrates an example analysis workflow. As illustrated, the system can identify a potential exchange (302) and connect relevant sensors (physical and/or virtual) to collect data regarding the exchange as well as the exchange contract data (304). In some cases, this collection of data can be receiving electrical signals indicating that the exchange took place and under what terms, whereas in other cases this can be capturing video or other data that can be analyzed to determine aspects of the exchange. The system then performs data cleaning/normalization (306) to ensure that the data captured by the sensors is in a desired format. The system then accesses the existing data model, and “hydrates” the graph model (308), meaning that the newly captured/normalized data is added to the graph model. In some cases, the next step can be to traverse the sub-graph to where the “exchange” node is not linked to the “exchange contract and terms” node (310), then highlight those nodes as recommendations. In other cases, the next step can be to extract metadata, then use the contract affinity edge to recommend the contract with the highest score (312). In other words, the system can make a recommendation for the specific scenario identified from the captured sensor data based on the highest return or other metric defined by the system.

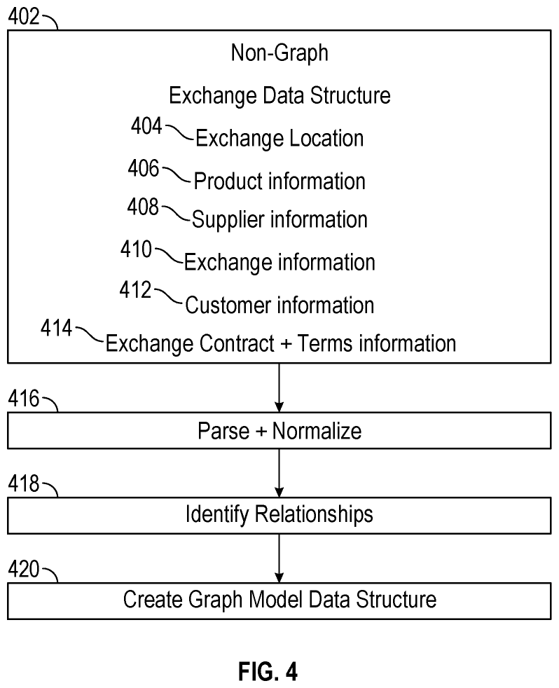

FIG. 4 illustrates conversion of a non-graph exchange data structure 402 into a graph model data structure. The non-graph data structure can include information such as exchange location 404, product information 406, supplier information 408, exchange information 410, customer information 412, and exchange contract and terms information 414. In other words, the non-graph data structure can contain information that corresponds to the nodes illustrated in FIG. 2. The system can parse and normalize the data contained within the non-graph exchange data structure 402. The parsing can, for example, analyze the data and break the data into specific parts, with descriptions of roles different entities have. The normalization can, for example, identify missing data or data in a different format than other non-graph exchange data structures and modify the data structure such that missing data is accounted for and the format matches. The system can then identify relationships 418 between entities based on the parsed, normalized data. Using the resulting relationships 418 and the parsed, normalized data, the system can create the graph model data structure 420 used to create the graph data model, an example of which is illustrated in FIG. 2. The graph model data structure 420 can be, for example, a text file stored in memory or in a database, where the text file identifies vertices (nodes and components) and edges (relationships between the nodes).

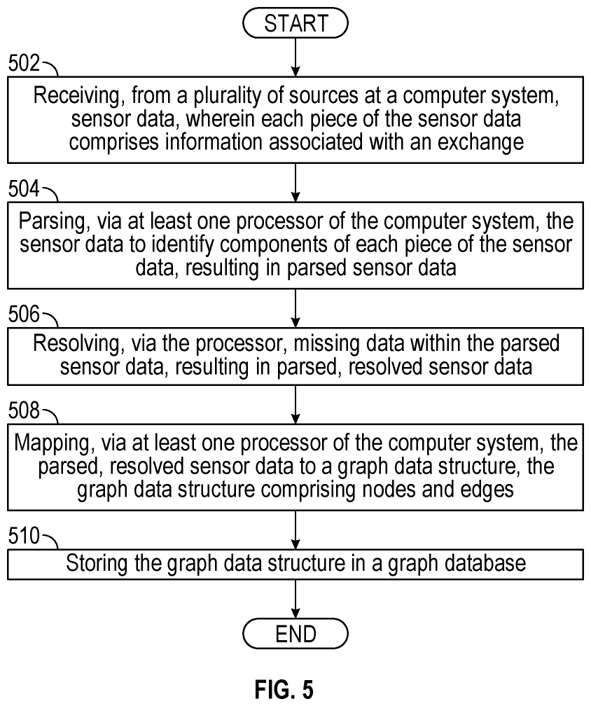

FIG. 5 illustrates an example method embodiment. As illustrated, systems configured as disclosed herein can receive, from a plurality of sources, sensor data, wherein each piece of the sensor data comprises information associated with an exchange (502). The system then parses, via at least one processor, the sensor data to identify components of each piece of the sensor data, resulting in parsed sensor data (504) and resolves, via the at least one processor, missing data within the parsed sensor data, resulting in parsed, resolved sensor data (506). The system can then map, via at least one processor, the parsed, resolved sensor data to a graph data structure, the graph data structure comprising nodes and edges (508), and store the graph data structure in a graph database (510). In some configurations, each node and each edge of the graph data structure can include metadata associated with the exchange.

In some configurations, the illustrated method can further include executing, via the at least one processor, an Artificial Intelligence (AI) algorithm using the graph data structure as an input, wherein the AI algorithm is at least one of: Centrality, Community Analysis, Graph Machine Learning and Embeddings, Path Optimization, Classification Analysis, Similarity Analysis, Topological Link Prediction, and Frequent Pattern Mining.

In some configurations, the resolving of the missing data can further include: identifying missing data within the parsed sensor data; filling in the missing data within the parsed sensor data; and resolving timing differences between pieces of the parsed sensor data.

In some configurations, the plurality of sources include one or more of: at least one database, at least one physical sensor, and at least one virtual sensor.

In some configurations, the nodes can include: a supplier location node, a product node, a customer node, a sales location node, an exchange node, and a sales contract and terms node. In such configurations, the edges can identify relationships between the nodes defined by the exchange for each piece of the parsed, resolved sensor data. In addition, in such configurations the edges can further identify at least one self-referencing relationship.

In some configurations, the illustrated method can further include: retrieving, at the system from the graph database, the graph data structure and a plurality of additional graph data structures, resulting in graph data; executing, via the at least one processor, a machine learning algorithm using the graph data, wherein output of the machine learning model comprises a pattern between relationships of nodes and edges within the graph data; and communicating, from the computer system to a remote computing device, the pattern.

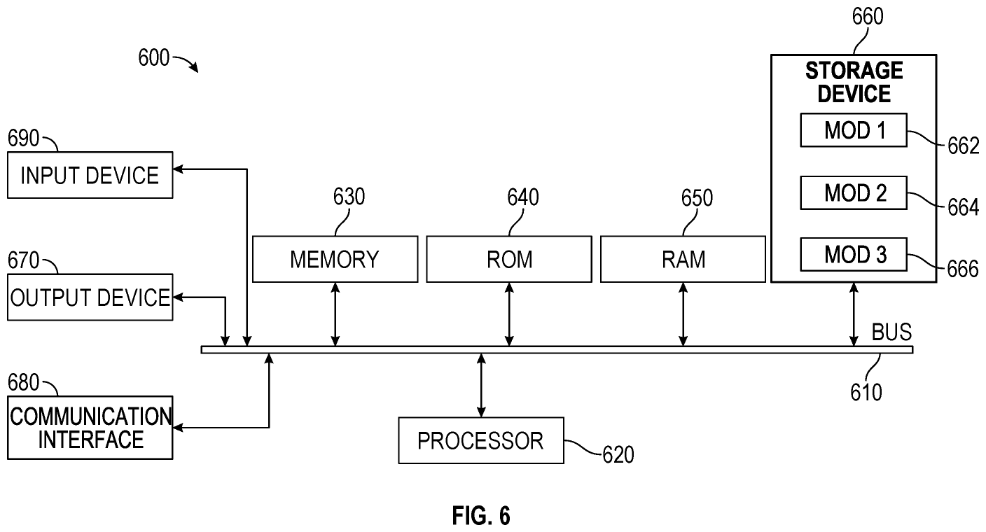

With reference to FIG. 6, an exemplary system includes a general-purpose computing device 600, including a processing unit (CPU or processor) 620 and a system bus 610 that couples various system components including the system memory 630 such as read-only memory (ROM) 640 and random access memory (RAM) 650 to the processor 620. The system 600 can include a cache of high-speed memory connected directly with, in close proximity to, or integrated as part of the processor 620. The system 600 copies data from the memory 630 and/or the storage device 660 to the cache for quick access by the processor 620. In this way, the cache provides a performance boost that avoids processor 620 delays while waiting for data. These and other modules can control or be configured to control the processor 620 to perform various actions. Other system memory 630 may be available for use as well. The memory 630 can include multiple different types of memory with different performance characteristics. It can be appreciated that the disclosure may operate on a computing device 600 with more than one processor 620 or on a group or cluster of computing devices networked together to provide greater processing capability. The processor 620 can include any general purpose processor and a hardware module or software module, such as module 1 662, module 2 664, and module 3 666 stored in storage device 660, configured to control the processor 620 as well as a special-purpose processor where software instructions are incorporated into the actual processor design. The processor 620 may essentially be a completely self-contained computing system, containing multiple cores or processors, a bus, memory controller, cache, etc. A multi-core processor may be symmetric or asymmetric.

The system bus 610 may be any of several types of bus structures including a memory bus or memory controller, a peripheral bus, and a local bus using any of a variety of bus architectures. A basic input/output (BIOS) stored in ROM 640 or the like, may provide the basic routine that helps to transfer information between elements within the computing device 600, such as during start-up. The computing device 600 further includes storage devices 660 such as a hard disk drive, a magnetic disk drive, an optical disk drive, tape drive or the like. The storage device 660 can include software modules 662, 664, 666 for controlling the processor 620. Other hardware or software modules are contemplated. The storage device 660 is connected to the system bus 610 by a drive interface. The drives and the associated computer-readable storage media provide nonvolatile storage of computer-readable instructions, data structures, program modules and other data for the computing device 600. In one aspect, a hardware module that performs a particular function includes the software component stored in a tangible computer-readable storage medium in connection with the necessary hardware components, such as the processor 620, bus 610, display 670, and so forth, to carry out the function. In another aspect, the system can use a processor and computer-readable storage medium to store instructions which, when executed by a processor (e.g., one or more processors), cause the processor to perform a method or other specific actions. The basic components and appropriate variations are contemplated depending on the type of device, such as whether the device 600 is a small, handheld computing device, a desktop computer, or a computer server.

Although the exemplary embodiment described herein employs the hard disk 660, other types of computer-readable media which can store data that are accessible by a computer, such as magnetic cassettes, flash memory cards, digital versatile disks, cartridges, random access memories (RAMs) 650, and read-only memory (ROM) 640, may also be used in the exemplary operating environment. Tangible computer-readable storage media, computer-readable storage devices, or computer-readable memory devices, expressly exclude media such as transitory waves, energy, carrier signals, electromagnetic waves, and signals per se.

To enable user interaction with the computing device 600, an input device 690 represents any number of input mechanisms, such as a microphone for speech, a touch-sensitive screen for gesture or graphical input, keyboard, mouse, motion input, speech and so forth. An output device 670 can also be one or more of a number of output mechanisms known to those of skill in the art. In some instances, multimodal systems enable a user to provide multiple types of input to communicate with the computing device 600. The communications interface 680 generally governs and manages the user input and system output. There is no restriction on operating on any particular hardware arrangement and therefore the basic features here may easily be substituted for improved hardware or firmware arrangements as they are developed.

The technology discussed herein makes reference to computer-based systems and actions taken by, and information sent to and from, computer-based systems. One of ordinary skill in the art will recognize that the inherent flexibility of computer-based systems allows for a great variety of possible configurations, combinations, and divisions of tasks and functionality between and among components. For instance, processes discussed herein can be implemented using a single computing device or multiple computing devices working in combination. Databases, memory, instructions, and applications can be implemented on a single system or distributed across multiple systems. Distributed components can operate sequentially or in parallel.

Use of language such as “at least one of X, Y, and Z,” “at least one of X, Y, or Z,” “at least one or more of X, Y, and Z,” “at least one or more of X, Y, or Z,” “at least one or more of X, Y, and/or Z,” or “at least one of X, Y, and/or Z,” are intended to be inclusive of both a single item (e.g., just X, or just Y, or just Z) and multiple items (e.g., {X and Y}, {X and Z}, {Y and Z}, or {X, Y, and Z}). The phrase “at least one of” and similar phrases are not intended to convey a requirement that each possible item must be present, although each possible item may be present.

The various embodiments described above are provided by way of illustration only and should not be construed to limit the scope of the disclosure. Various modifications and changes may be made to the principles described herein without following the example embodiments and applications illustrated and described herein, and without departing from the spirit and scope of the disclosure.

The concepts disclosed herein capture a framework for modeling supply chain and operations data. It does so by enabling a graph data model that can create relationships between different entities based on distribution industry records. Traditionally, the supply chain and operations data may be stored in entity tables in a tabular structure. In order to derive any meaningful analysis from that tabular structure, complicated merge queries are created. The complication is due to the predefined structures, i.e., table definition in terms of primary and foreign keys. These pre-defined structures vary from one database to another.

By contrast, systems enabled according to this disclosure have relationships are stored at the individual record level that is optimized for the distribution industry. The distribution industry dataset can be unique in the way that it is highly connected compared to other datasets. The resulting graph model has a system of vertex and edge names which can form human-readable sentences, and the relationships between the entities are understandable. Unlike the traditional tabular data model, both technical and non-technical users can understand graph data models.

Other attempts to extract business value from the supply chain and operations data often store different entities in a tabular structure, then executing a rule-based algorithm search within it. Such methods require the design of complex and well-elaborated database queries, with filters and merges/joins, so that the final output can be meaningful and properly represent the data required by users and by machine learning models. These database queries are very convoluted due to the predefined data structure intrinsic in the tabular format, i.e., tables defined and connected through the concept of primary and foreign keys, aggravating the process of capturing the data.

The methods disclosed herein address the data relationship issues from the tabular data structure, facilitating an overall analysis of the data, the identification of its patterns, and the performance of the mechanism. These elements are crucial from a business perspective since they provide companies with means to achieve competitiveness in the distribution market and consequently increase its profit margin.

For example, the graph model structures and associated methods disclosed herein produce a great advantage when compared with the tabular structure. The greatest advantage is the possibility of creating relationships at a record level instead of at an entity level. This allows the data to be more dynamic and flexible, which properly depicts the reality of the data while maintaining the accuracy of the information. This graph model structure can generate an immensurable business value and competitive advantage in the distribution market since new business opportunities can be captured and new insights can be extracted from the data. For example, although fixed relationships are predefined in the graph model, new “virtual” or indirect relationships can be inferred and detected within the model, enabling a better feature engineering that can be used to feed predictive machine learning models. The graph model structure also enables different data insights by using graph theory and advanced graph algorithms as well, such as link prediction, connectivity, path, community, centrality, similarity, etc.

We claim:

1. A method comprising:
receiving, from a plurality of sources at a computer system, sensor data, wherein each piece of the sensor data comprises information associated with an exchange;
parsing, via at least one processor of the computer system, the sensor data to identify components of each piece of the sensor data, resulting in parsed sensor data;
resolving, via the at least one processor, missing data within the parsed sensor data, resulting in parsed, resolved sensor data;
mapping, via the at least one processor of the computer system, the parsed, resolved sensor data to a graph data structure, the graph data structure comprising nodes and edges, wherein each node and each edge of the graph data structure comprises metadata associated with the exchange; and
storing the graph data structure in a graph database.

2. The method of claim 1, further comprising:
executing, via the at least one processor, an Artificial Intelligence (AI) algorithm using the graph data structure as an input, wherein the AI algorithm comprises at least one of: Centrality, Community Analysis, Graph Machine Learning and Embeddings, Path Optimization, Classification Analysis, Similarity Analysis, Topological Link Prediction, and Frequent Pattern Mining.

3. The method of claim 1, wherein the resolving of the missing data further comprises:
identifying missing data within the parsed sensor data;
filling in the missing data within the parsed sensor data; and
resolving timing differences between pieces of the parsed sensor data.

4. The method of claim 1, wherein the plurality of sources comprise:
at least one database; and
at least one physical sensor.

5. The method of claim 1, wherein the nodes comprise:
a supplier node;
a product node;
a customer node;
an exchange location node;
an exchange node; and
a sales contract and terms node.

6. The method of claim 5, wherein the edges identify relationships between the nodes defined by the exchange for each piece of the parsed, resolved sensor data.

7. The method of claim 6, wherein the edges further identify at least one self-referencing relationship.

8. The method of claim 1, further comprising:
retrieving, at the computer system from the graph database, the graph data structure and a plurality of additional graph data structures, resulting in graph data;
executing, via the at least one processor, a machine learning algorithm using the graph data, wherein output of the machine learning model comprises a pattern between relationships of nodes and edges within the graph data; and
communicating, from the computer system to a remote computing device, the pattern.

9. A system comprising:
at least one processor; and
a non-transitory computer-readable storage medium having instructions stored which, when executed by the at least one processor, cause the at least one processor to perform operations comprising:
receiving, from a plurality of sources, sensor data, wherein each piece of the sensor data comprises information associated with an exchange;
parsing the sensor data to identify components of each piece of the sensor data, resulting in parsed sensor data;
resolving missing data within the parsed sensor data, resulting in parsed, resolved sensor data;
mapping the parsed, resolved sensor data to a graph data structure, the graph data structure comprising nodes and edges; and
storing the graph data structure in a graph database.

10. The system of claim 9, wherein each node and each edge of the graph data structure comprises metadata associated with the exchange.

11. The system of claim 9, wherein the resolving of the missing data further comprises:
identifying missing data within the parsed sensor data;
filling in the missing data within the parsed sensor data; and
resolving timing differences between pieces of the parsed sensor data.

12. The system of claim 9, wherein the plurality of sources comprise:
at least one database; and
at least one physical sensor.

13. The system of claim 9, wherein the nodes comprise:
a supplier node;
a product node;
a customer node;
an exchange location node;
an exchange node; and
a sales contract and terms node.

14. The system of claim 13, wherein the edges identify relationships between the nodes defined by the exchange for each piece of the parsed, resolved sensor data.

15. The system of claim 14, wherein the edges further identify at least one self-referencing relationship.

16. The system of claim 9, the non-transitory computer-readable storage medium having additional instructions stored which, when executed by the at least one processor, cause the at least one processor to perform operations comprising:
retrieving, from the graph database, the graph data structure and a plurality of additional graph data structures, resulting in graph data;
executing a machine learning algorithm using the graph data, wherein output of the machine learning model comprises a pattern between relationships of nodes and edges within the graph data; and
communicating, to a remote computing device, the pattern.

17. A non-transitory computer-readable storage medium having instructions stored which, when executed by at least one processor, cause the at least one processor to perform operations comprising:
receiving, from a plurality of sources, sensor data, wherein each piece of the sensor data comprises information associated with an exchange;
parsing the sensor data to identify components of each piece of the sensor data, resulting in parsed sensor data;
resolving missing data within the parsed sensor data, resulting in parsed, resolved sensor data;
mapping the parsed, resolved sensor data to a graph data structure, the graph data structure comprising nodes and edges; and
storing the graph data structure in a graph database.

18. The non-transitory computer-readable storage medium of claim 17, wherein each node and each edge of the graph data structure comprises metadata associated with the exchange.

19. The non-transitory computer-readable storage medium of claim 17, wherein the resolving of the missing data further comprises:
identifying missing data within the parsed sensor data;
filling in the missing data within the parsed sensor data; and
resolving timing differences between pieces of the parsed sensor data.

20. The non-transitory computer-readable storage medium of claim 17, wherein the plurality of sources comprise:
at least one database; and
at least one physical sensor.
